(19) United States
(12) Patent Application Publication
(10) Pub. No.: US 2015/0339647 A1
(43) Pub. Date: Nov. 26, 2015

(54) COMMODITY INFORMATION INPUT APPARATUS AND COMMODITY INFORMATION INPUT METHOD

(71) Applicant: TOSHIBA TEC KABUSHIKI KAISHA, Tokyo (JP)

(72) Inventor: Hiroyuki Okuyama, Hiratsuka-shi (JP)

(73) Assignee: TOSHIBA TEC KABUSHIKI KAISHA, Tokyo (JP)

(21) Appl. No.: 14/285,691

(22) Filed: May 23, 2014

(51) Int. Cl. G06Q 20/20

(52) U.S. Cl. CPC G06Q 20/20

(57) ABSTRACT

A commodity information input apparatus comprises a recognition section configured to recognize an input voice; a detection section configured to detect, from a commodity database, data of more than one candidate for an input commodity based on the result of the recognition on the input voice; an output section configured to output information related to the more than one candidate for the input commodity; an acceptance section configured to accept the determination on the more than one candidate for the input commodity; an input section configured to input the data of the more than one candidate for the input commodity to an input database corresponding to the determination.

### FIELD

Embodiments described herein relate to a commodity information input apparatus and a commodity information input method.

### BACKGROUND

A commodity management system using a POS (Point of sale) terminal is being popularized. For example, a customer selects commodities and reads names of the commodities by reference to a commodity menu. The operator of the POS terminal listens to the read commodity names and registers (inputs) data of the commodities into the POS terminal. The POS terminal sends the registered commodity data to a management server so that the management server can manage the commodities.

### BRIEF DESCRIPTION OF THE DRAWINGS

FIG. 1 is a diagram exemplifying the schematic configuration of a POS system;

FIG. 2 is a diagram exemplifying the appearance of a handy terminal;

FIG. 3 is a diagram exemplifying the appearance of a handy terminal;

FIG. 4 is a diagram exemplifying the control blocks of the handy terminal which constitutes the POS system;

FIG. 5 is a diagram exemplifying the configuration of processing blocks related to an order information registration processing section of a POS system; and

FIG. 6 is a flowchart exemplifying a processing relating to the order information registration processing section of a POS system.

### DETAILED DESCRIPTION

In accordance with an embodiment, a commodity information input apparatus comprises a recognition section configured to recognize an input voice; a detection section configured to detect, from a commodity database, data of more than one candidate for an input commodity based on the result of the recognition on the input voice; an output section configured to output information related to the more than one candidate for the input commodity; an acceptance section configured to accept the determination on the more than one candidate for the input commodity; an input section configured to input the data of the more than one candidate for the input commodity to an input database corresponding to the determination.

An order acceptance system (commodity information input system) is imported in a restaurant such as a family restaurant or pub, and in the embodiment, as such an order acceptance system, a POS system is described below with reference to the accompanying drawings.

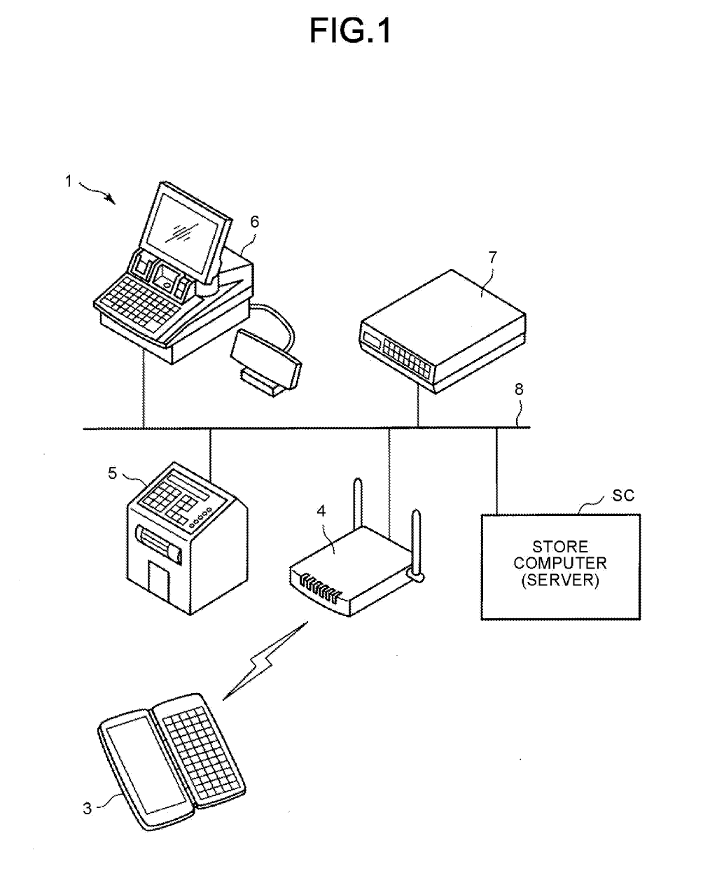

FIG. 1 is a diagram exemplifying the schematic configuration of a POS system 1. The POS system 1 comprises a handy terminal 3 (commodity information input device), a wireless relay unit 4, a kitchen terminal 5, a checkout terminal 6, a control station 7, a network 8 such as a LAN (Local Area Network) and a store computer SC (server). The handy terminal 3 wirelessly communicates with the wireless relay unit 4. The network 8 connects the wireless relay unit 4, the kitchen terminal 5, the checkout terminal 6 and the control station 7. A bidirectional data communication can be realized between the handy terminal 3 and the control station 7 via the wireless relay unit 4. Further, the handy terminal 3, the wireless relay unit 4, the kitchen terminal 5 and the checkout terminal 6 can be arranged in an optional number.

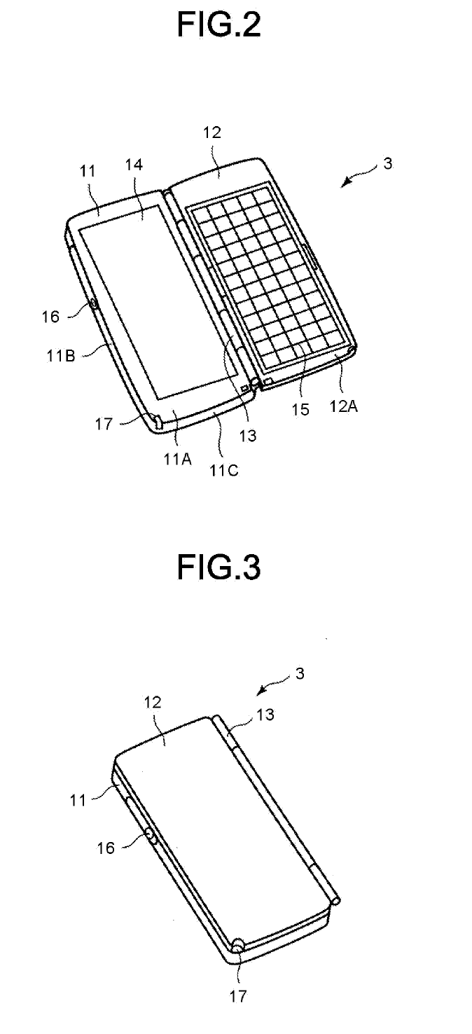

FIG. 2 and FIG. 3 are diagrams exemplifying the appearance of the handy terminal 3. FIG. 2 shows a state in which a second structural body 12 is opened with respect to a first structural body 11 which will be described later, and FIG. 3 shows a state in which the second structural body 12 is closed with respect to the first structural body 11. The handy terminal 3 comprises the first structural body 11 configured on the left side in FIG. 2 and the second structural body 12 configured on the right side in FIG. 2. The first structural body 11 and the second structural body 12 are both in an almost cuboid shape. The second structural body 12 is connected with the first structural body 11 in a freely rotatable manner via a fastener 13 such as a hinge and the like. With the fastener 13, the second structural body 12 is, with respect to the first structural body 11, performed opening/closing operation between an opening state (refer to FIG. 2) and a closed state (refer to FIG. 3).

A touch panel 14 (display section) is arranged on the side 11A of the first structural body 11 which is exposed when the second structural body 12 is opened with respect to the first structural body 11. The keyboard 15 is arranged on the side 12A of the second structural body 12 which is exposed when the second structural body 12 is opened with respect to the first structural body 11.

A power switch 16 is arranged on the left lateral side 11B (refer to FIG. 2) of the first structural body 11. Further, a LED 17 is arranged on the boundary part of the side 11A of the first structural body 11 on which the touch panel 14 is arranged and the lower lateral side 11C shown in FIG. 2.

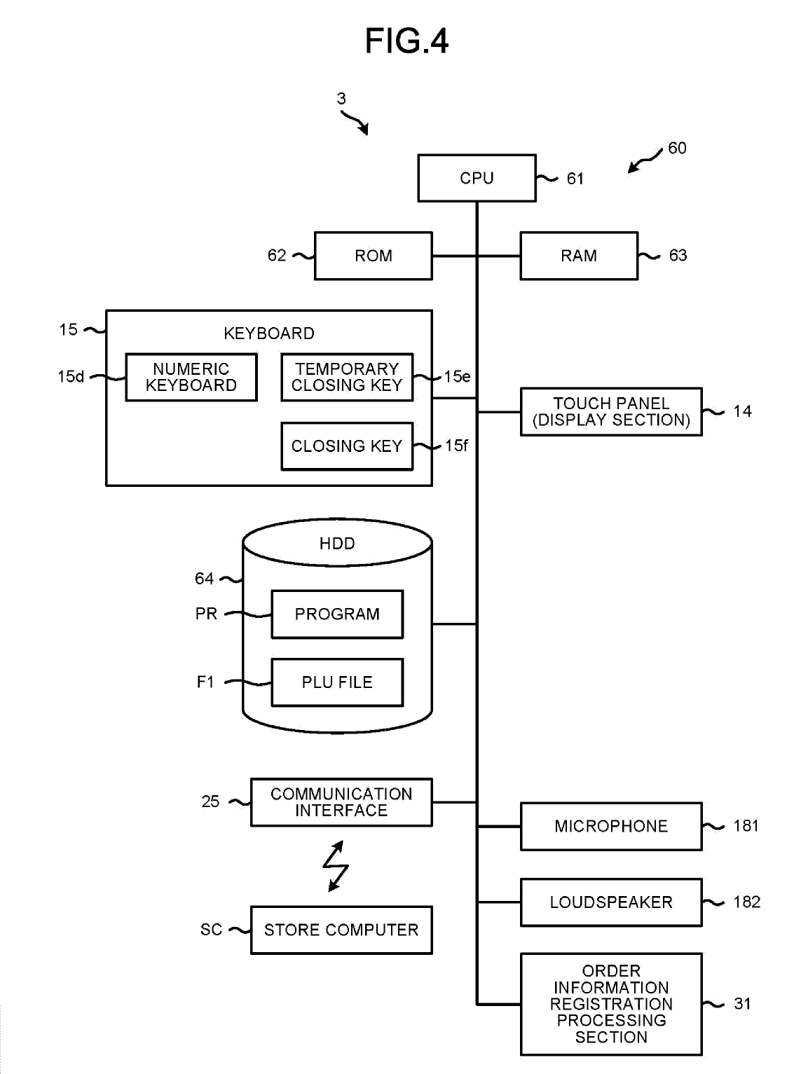

FIG. 4 is a diagram exemplifying a control block of the handy terminal 3 which constitutes the POS system.

The operator can visually check the content displayed on the touch panel 14 of the handy terminal 3, and the customer can also visually check the content displayed on the touch panel 14 when the display surface of the touch panel 14 faces the customer. Further, the touch panel 14 may be arranged as a display device for the use by the operator while another different display device is arranged for the customer. In this case, the same content can be displayed on the touch panel 14 and the another display device for the operator and the customer to confirm the displayed content at the same time.

Further, the handy terminal 3 is provided with a microcomputer 60 functioning as an information processing section for carrying out an information processing. The microcomputer 60 is formed by connecting, via a bus line, a ROM (Read Only Memory) 62 and a RAM (Random Access Memory) 63 with a CPU (Central Processing Unit) 61 that executes various processing to control each other section. The keyboard 15 and the touch panel 14 both of which are connected with the CPU 61 of the handy terminal 3 via various input/output circuits. These components are controlled by the CPU 61. The keyboard 15 includes a numeric keyboard 15d on the surface of which numerals ‘1’, ‘2’ , ‘3’ and the like and operators including ‘*’ are indicated, a temporary closing key 15e and a closing key 15f.

Further, the handy terminal 3 comprises a microphone 181, a loudspeaker 182 and an order information registration processing section 131. The microphone 181 inputs the order information (voice) from a customer and outputs the order information as voice data. The loudspeaker 182 outputs the voice such as the result of the recognition on the order information or various kinds of guidance. The order information registration processing of the order information registration processing section 31 will be described later in detail.

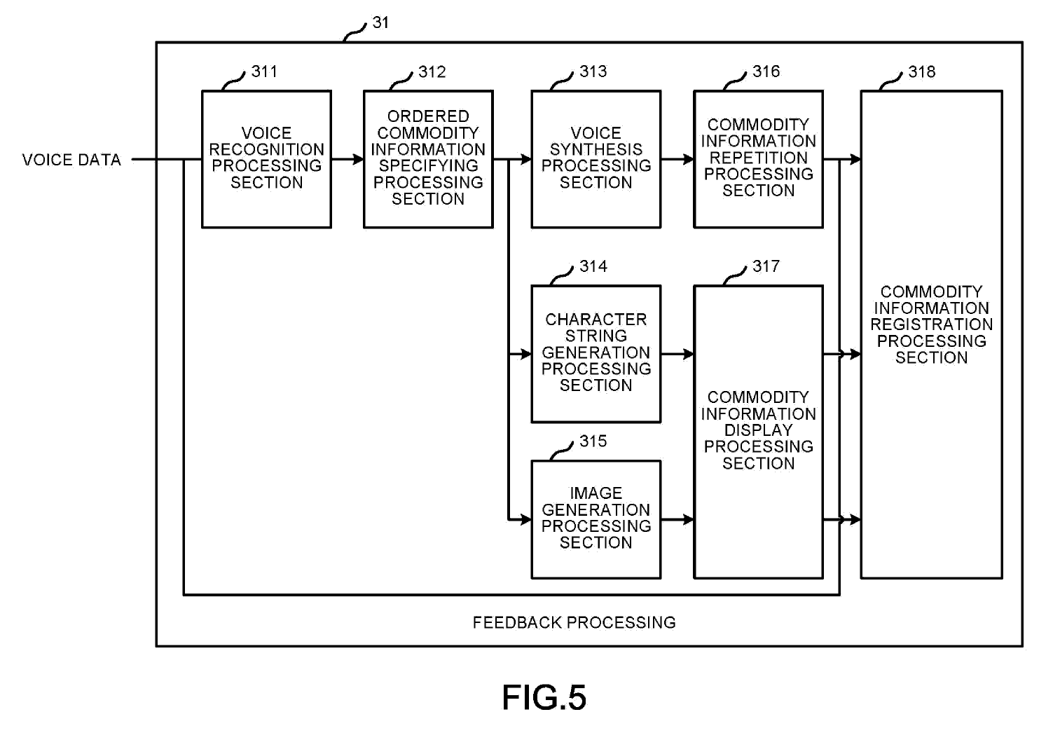

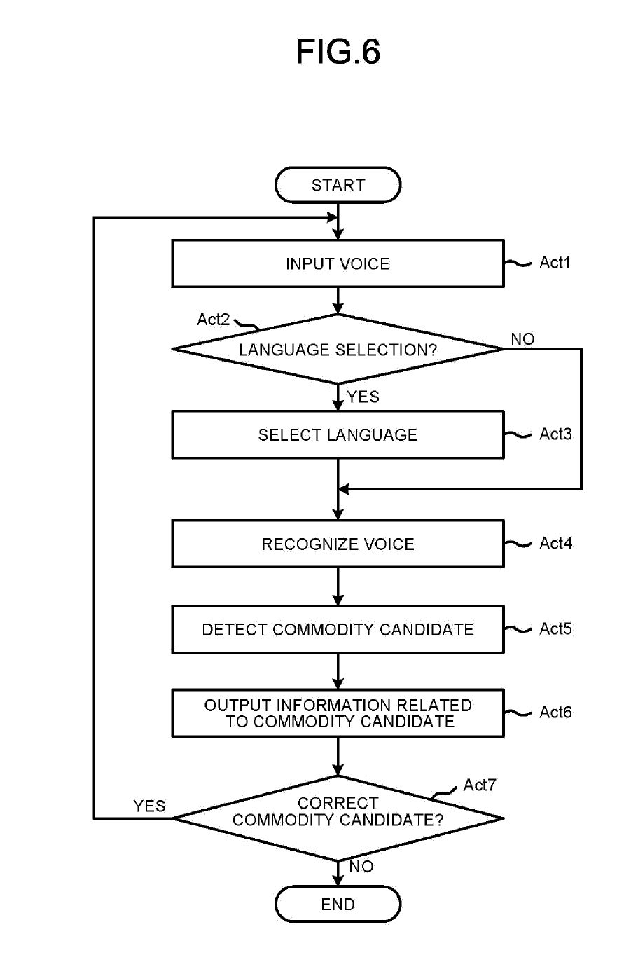

FIG. 5 is a diagram exemplifying the configuration of processing blocks related to the order information registration processing section 31 of the POS system. FIG. 6 is a flowchart exemplifying a processing relating to the order information registration processing section of the POS system.

For example, a customer selects a commodity and reads the name of the commodity by reference to a commodity menu. The microphone 181 of the handy terminal 3 inputs the name (voice) of the commodity read by the customer (Act 1) and outputs the name of the commodity as first voice data. For example, when an automatic language selection mode is set to be valid in a voice recognition processing section 311 (Yes in Act 2), the voice recognition processing section 311 inputs the first voice data from the microphone 181, selects (determines) the language (e.g. a firs language) of the first voice data (Act 3), and recognizes the first voice data based on the voice feature amount of the selected language (Act 4). In the case of the language selection, the corresponding language is one of the languages used inmost POS systems, including English, French, Chinese, Japanese and the like. When the automatic language selection mode is set to be invalid in the voice recognition processing section 311, for example, English is designated (No in Act 2), the first voice data is recognized based on the designated language (English) (Act 4).

The voice recognition result (data of more than one commodity candidate) output from the voice recognition processing section 311 is output to an ordered commodity information specifying processing section 312. The following processing is described here according to several voice recognition results. For example, the following processing is described on the assumption of a first voice recognition result (orange juice) and a second voice recognition result (orange juice and apple juice). Assume that the former result is the reading of one commodity (orange juice) by the customer and the latter result is the reading of a plurality of commodities (orange juice and apple juice) by the customer.

The ordered commodity information determination processing section 312 detects candidates for the more than one ordered commodity by the customer (Act 5) or specifies the more than one ordered commodity by the customer by comparing the dictionary data (commodity database) stored in a HDD 64 with the voice recognition result (data of more than one commodity candidates). For example, assume that a commodity ‘orange juice’ having a first similarity degree and commodities ‘apple juice’ and ‘lemon juice’ having a smaller second similarity degree than the first similarity degree are detected aiming at the first voice recognition result (orange juice). Further, assume that commodities ‘orange juice’ and ‘apple juice’ having a first similarity degree and commodities ‘lemon juice’ and ‘melon juice’ having a smaller second similarity degree than the first similarity degree are detected aiming at the second voice recognition result (orange juice and apple juice).

A voice synthesis processing section 313 generates second voice data corresponding to the data of the more than one commodity candidate. Further, corresponding to the selection of the first language by the voice recognition processing section 311, the voice synthesis processing section 313 generates the second voice data in the first language. Further, the first voice data and the second voice data may be the same content. Further, a character string generation processing section 314 generates character string data corresponding to the data of the more than one commodity candidate. Here, corresponding to the selection of the first language by the voice recognition processing section 311, the character string generation processing section 314 generates the character string data in the first language. Further, the character string generation processing section 314 may generate the character string data in a plurality of languages including the first language. For example, if a second language is comprehensible to the operator, the character string generation processing section 314 generates the character string data in the first and the second language through designating the second language in advance. Further, an image generation processing section 315 generates illustrative image data corresponding to the data of the more than one commodity candidate.

A commodity information repetition processing section 316 outputs (repeats), via the loudspeaker 182 shown in FIG. 4, information related to the more than one commodity candidate (the name of the ordered commodity) based on the second voice data (the second voice data of the first language) (Act 6). The customer confirms the repeated content and informs the operator of a confirmation result. Further, a commodity information display processing section 317 displays, on the touch panel 14, an image based on the character string data (the character string data in the first language or in the first and the second language) corresponding to the data of the more than one commodity candidate and an image based on the illustrative image data corresponding to the data of the more than one commodity candidate (Act 6). By displaying the character string data and the image data, the possibility that the customer makes mistakes when confirming commodities is reduced. Moreover, if the character string data and the image data are repeated in the first language, as the first language is the same as the language used by the customer, the customer can indeed understand the character string data and the image data. Further, if the character string data and the image data are displayed in the first language, as the first language is the same as the language used by the customer, the customer can indeed understand the character string data and the image data. Further, if the character string data and the image data are displayed in the second language, as the second language is the same as the language used by the operator, the operator can also indeed understand the character string data and the image data.

When the first voice recognition result (orange juice) is obtained, basically, information related to a commodity ‘orange juice’ having the first similarity degree is output, however, information related to the commodity ‘orange juice’ having the first similarity degree may be output mainly (displayed in a first size), accompanied by the output of commodities ‘apple juice’ and ‘lemon juice’ having the second similarity degree (displayed in a smaller second size than the first size) Similarly, when the second voice recognition result (orange juice and apple juice) is obtained, basically, information related to commodities ‘orange juice’ and ‘apple juice’ having the first similarity degree is output, however, information related to the commodities ‘orange juice’ and ‘apple juice’ having the first similarity degree may be output mainly (displayed in a first size), accompanied by the output of commodities ‘lemon juice’ and ‘melon juice’ having the second similarity degree (displayed in a smaller second size than the first size).

The operator inputs information indicating whether or not to correct the registered commodities information to the handy terminal 3, if needed. If information indicating no correction (confirmation) is input via the keyboard 15 or the touch panel 14 of the handy terminal 3 (No in Act 7), for example, the data of the commodity candidate is input to the input database of the server (Store Computer: SC) via a communication interface 25.

If information indicating a correction operation is input via the keyboard 15 or the touch panel 14 of the handy terminal 3 (Yes in Act 7), the customer reads the name of a commodity again to restart the processing starting from the voice recognition processing carried out by the voice recognition processing section 311 (Act 1-Act 6) (the feedback processing shown in FIG. 5).

Alternatively, if information indicating a correction operation is input via the keyboard 15 or the touch panel 14 of the handy terminal 3 (Yes in Act 7), by switching from the information displayed on the touch panel 14 related to the commodity ‘orange juice’ having the first similarity degree to information related to the commodities ‘apple juice’ and ‘lemon juice’ having the second similarity degree (information related to more than one input corrected commodity candidate), the designation on ‘orange juice’ or the designation on ‘lemon juice’ or the designation on ‘orange juice’ and ‘lemon juice’ can be accepted. Alternatively, if information indicating a correction operation is input via the keyboard 15 or the touch panel 14 of the handy terminal 3 (Yes in Act 7), by switching from the information displayed on the touch panel 14 related to the commodities ‘orange juice’ and ‘apple juice’ having the first similarity degree to information related to the commodities ‘lemon juice’ and ‘melon juice’ having the second similarity degree (information related to more than one input corrected commodity candidate), the designation on ‘lemon juice’ or the designation on ‘melon juice’ or the designation on ‘lemon juice’ and ‘melon juice’ can be accepted.

Further, in the description above, the storage of dictionary data (commodity database) in the HDD 64 of the handy terminal 3 is described; however, the dictionary data may also be managed by other devices excluding the handy terminal 3. For example, if needed, the handy terminal 3 may receive the dictionary data from an external server and sends the voice recognition result (data of the more than one commodity candidate) to the external server, and the external server compares the dictionary data with the voice recognition result to detect candidates for the ordered commodity and feeds the result of the detection on the ordered commodity candidate back to the handy terminal 3.

According to the embodiment, when a customer inputs commodity order information to the handy terminal 3, the commodity information can be specified automatically through a voice recognition process, without manually inputting information by an operator, and then registered in a server. At this time, the customer is required to confirm a name corresponding to the commodity information and information associating character string data with image data, further, the correction on the determined commodity information can be accepted.

Thus, the possibility is reduced that the customer, when registering order information, presses an error commodity key or that an error commodity is registered on an order as the languages used by the customer and the operator are different.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity information input apparatus, comprising:
a recognition section configured to recognize an input voice;
a detection section configured to detect, from a commodity database, data of more than one candidate for an input commodity based on the result of the recognition on the input voice;
an output section configured to output information related to the more than one candidate for the input commodity;
an acceptance section configured to accept the determination on the more than one candidate for the input commodity; and
an input section configured to input the data of the more than one candidate for the input commodity to an input database corresponding to the determination.

2. The commodity information input apparatus according to claim 1, wherein
the recognition section determines the language of the input voice; and
the output section outputs the voice information related to the more than one candidate for the input commodity in a language the same as the language of the input voice.

3. The commodity information input apparatus according to claim 1, wherein
the recognition section determines the language of the input voice; and
the output section displays information related to the more than one candidate for the input commodity in a language the same as the language of the input voice.

4. The commodity information input apparatus according to claim 1, wherein
the recognition section recognizes the language of the input voice; and
the output section displays information related to the more than one candidate for the input commodity in a plurality of languages including a language the same as the language of the input voice.

5. The commodity information input apparatus according to claim 1, wherein
the detection section detects data of a plurality of candidates for the input commodity based on the result of the recognition;
the output section outputs information related to the plurality of candidates for the input commodity;
the acceptance section accepts a first determination of determining one of the plurality of candidates for the input commodity or a second determination of determining more than two of the plurality of candidates for the input commodity; and
the input section inputs data of the one candidate for the input commodity into the input database corresponding to the first determination, data of the more than two candidates for the input commodity into the input database corresponding to the second determination.

6. The commodity information input apparatus according to claim 1, wherein
the acceptance section accepts the correction on a candidate for the input commodity; and
the output section outputs information related to more than one input corrected commodity candidate corresponding to the correction.

7. The commodity information input apparatus according to claim 6, wherein
the detection section detects data of more than one candidate for the input commodity having a first similarity degree and data of more than one candidate for the input commodity having a smaller second similarity degree than the first similarity degree aiming at the result of the recognition on the input voice; and
the output section outputs information related to the more than one candidate for the input commodity having the first similarity degree and outputs, corresponding to the correction, information related to the more than one candidate for the input commodity having the second similarity degree as information related to more than one input corrected commodity candidate.

8. A commodity information input method, comprising:
recognizing an input voice;
detecting, from a commodity database, data of more than one candidate for an input commodity based on the result of the recognition on the input voice;
outputting information related to the more than one candidate for the input commodity;
accepting the determination on the more than one candidate for the input commodity; and
inputting the data of the more than one candidate for the input commodity to an input database corresponding to the determination.
